(19) United States
(12) Patent Application Publication
(10) Pub. No.: US 2024/0069239 A1
(43) Pub. Date: Feb. 29, 2024

(54) METHODS USING DUAL ARRIVAL COMPRESSIONAL AND SHEAR ARRIVAL EVENTS IN LAYERED FORMATIONS FOR FORMATION EVALUATION, GEOMECHANICS, WELL PLACEMENT, AND COMPLETION DESIGN

(71) Applicants: Schlumberger Technology Corporation, Sugar Land, TX (US); Saudi Arabian Oil Company, Dhahran (SA)

(72) Inventors: Nicholas N. Bennett, Cambridge, MA (US); John Adam Donald, Dubai (AE); Olusegun M. Akinyose, Corby (GB); Shouxiang Mark Ma, Dhahran (SA); Sherif Ghadiry, Dhahran (SA); Wael Abdallah, Dhahran (SA)

(21) Appl. No.: 18/458,255

(22) Filed: Aug. 30, 2023

Related U.S. Application Data
(60) Provisional application No. 63/374,040, filed on Aug. 31, 2022.

(51) Int. Cl. G01V 1/50; E21B 7/04; E21B 44/00; E21B 49/00

(52) U.S. Cl. CPC G01V 1/50; E21B 7/04; E21B 44/00; E21B 49/00; E21B 2200/20; G01V 2200/16; G01V 2210/6242; G01V 2210/6244; G01V 2210/6246; G01V 2210/64

(57) ABSTRACT

Methods and systems are provided that perform sonic measurements in a high-angle wellbore or horizontal wellbore or vertical wellbore penetrating highly dipped formation layers where the formation layers can have a high degree of dip relative to the wellbore. Sonic data can be generated from the sonic measurements and processed using multiple arrival event processing to determine formation porosity, elastic rock properties and geometric information for a tool layer and nearby shoulder bed. Such information can be integrated into a 2D or 3D layered model of the formation. The elastic rock properties of the tool layer and shoulder bed derived from the multiple arrival event processing can provide more representative elastic property values, which can account for heterogeneity along the wellbore. Furthermore, the method can involve using at least part of the properties including porosity, elastic rock properties, and geometric information for the tool layer and shoulder bed for well placement (geosteering) and well completion optimization.

### CROSS-REFERENCE TO RELATED APPLICATIONS

This application claims priority from U.S. Provisional Appl. No. 63/374,040, filed on Aug. 31, 2022, herein incorporated by reference in its entirety.

### FIELD

Aspects of the disclosure relate to determining geological properties of hydrocarbon-bearing formations. More specifically, aspects of the disclosure relate to determining geological properties from layered formations from sonic waveforms that exhibit dual arrivals from a tool layer and from a nearby bed boundary.

### BACKGROUND

Sonic measurements are widely used today in oil and gas exploration and development operations because they carry important geophysics, petrophysics, and geomechanics information about the subsurface. From a geophysics point of view, sonic measurements provide velocity model building and time-to-depth conversion for various seismic measurements. From a petrophysics point of view, sonic measurements can provide important correlations with formation layer porosity. When shear information is available, sonic measurements can also provide critical information about formation elastic rock properties; rock strength, and anisotropy.

Sonic logging technology is designed primarily to measure compressional and shear slowness as a function of measured depth along the well trajectory. The traditional interpretation methods used for sonic measurements were originally designed for vertical wells. Here the most significant processing challenge is often distinguishing the formation slownesses in thin layers, particularly layers whose thickness is less than the aperture (length) of the receiver array.

Today, sonic measurements are increasingly acquired in wellbores that traverse formation layers that have a high degree of dip relative to the wellbore (i.e., high-angle wellbores, horizontal wellbores, and vertical wellbores penetrating highly dipped formation layers). In this case, the sonic measurements are sensitive to the properties of the adjacent formation layers. It is well known that multiple sonic arrival signals can be detected on the azimuthal receivers of a sonic logging tool where the compressional (P) and shear (S) waves propagate, including compressional (P) arrivals and shear (S) arrivals arising from propagation in the tool layer in a near-wellbore region that surrounds (or at least partially surrounds) the wellbore (which are referred to as ‘tool layer arrivals’) and compressional (P) arrivals and shear (S) arrivals arising from refraction and reflection along nearby shoulder beds (which are referred to as ‘shoulder bed arrivals’). This is commonly observed when the sonic logging tool is located near multiple formation layers.

FIG. 1 illustrates multiple arrival events presented in sonic logs acquired in high-angle wellbores. These multiple arrival events present many candidate values for compressional and shear formation slowness. The multiple arrival events arise from the multi-pathing of wavefronts propagating not just in the tool layer but also the wavefronts propagating and refracting through nearby shoulder beds, as illustrated in FIG. 2. Thus, in high-angle wells and other wellbores that traverse formation layers that have a high degree of dip relative to the wellbore, these dual arrival events, in fact, can carry important information about the tool layer and nearby shoulder beds.

From the traditional sonic processing point of view, these multiple values for compressional and shear slowness were often viewed as nuisance artifacts or tool failures to be eliminated by a subsequent expert interpretation/post-processing. Furthermore, the standard one-dimensional (1D) coherence processing of the sonic waveforms will not distinguish between the tool layer arrivals and the shoulder bed arrivals and thus is incapable of yielding reliable results that are consistent with petrophysical measurements (such as density, neutron, and image logs) of the formation layers, which can impact applications of the sonic logs in determining properties of the formation, such as porosity and elastic rock properties (rock stiffness).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure describes a workflow and systems that performs sonic measurements in a high-angle wellbore or horizontal wellbore or vertical wellbore penetrating highly dipped formation layers where the formation layers can have a high degree of dip relative to the wellbore. Sonic data can be generated from the sonic measurements and processed using multiple arrival event processing to determine formation porosity, elastic rock properties and geometric information for a tool layer and nearby shoulder bed. The tool layer is disposed in a near-wellbore region that surrounds (or at least partially surrounds) the wellbore. The shoulder bed can include one or more formation layers disposed above or below the tool layer in a high-angle wellbore or horizontal wellbore, or the shoulder bed can include one or more formation layers disposed on opposite sides of the tool layer in a vertical wellbore penetrating dipped formation layers. Such information can be integrated into a 2D or 3D layered model of the formation. The elastic rock properties of the tool layer and shoulder bed derived from the multiple arrival event processing can provide more representative elastic property values, which can account for heterogeneity along the wellbore. Furthermore, the method can involve using at least part of the formation porosity, elastic rock properties and geometric information for the tool layer and shoulder bed as derived from the sonic measurements for well placement (geosteering) and well completion optimization.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates sonic waveforms in a high-angle well where dual compressional and shear arrivals present themselves.

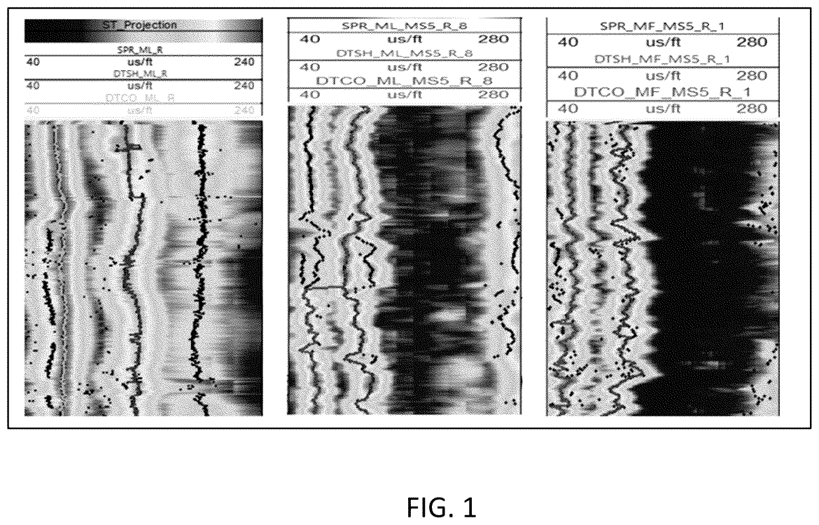

FIG. 2 is a schematic diagram showing a sonic logging tool deployed in a horizontal wellbore, including propagation paths for compressional and shear wavefronts through a tool layer and nearby shoulder bed.

FIG. 3 illustrates an example system that includes various components for modeling a geologic environment and various equipment associated with the geologic environment.

FIG. 4 illustrates an example of a sedimentary basin, an example of a method, an example of a formation, an example of a wellbore, an example of a downhole tool, and an example of a convention for dip.

FIG. 5 is a flowchart of a workflow for drilling and placing a highly-deviated wellbore according to an aspect of the present disclosure.

FIG. 6 is a flowchart of a workflow for processing azimuthal sonic data to determine compressional and shear slownesses from tool layer arrivals, compressional and shear slownesses from shoulder bed arrivals, and the dip/azimuth of the shoulder bed and distance to the shoulder bed boundary according to an aspect of the present disclosure.

FIG. 7 is a schematic diagram of a vertical well in a high-angle bed scenario.

FIG. 8 depicts plots that illustrate an example 1D model of elastic properties (Poisson's ratio) and stress properties distributed along a lateral wellbore.

FIG. 9 depicts plots that illustrate rock and fluid properties together with perforations and fracture stages distributed along a lateral wellbore, which can be used to plan hydraulic fracturing operations of the wellbore.

FIG. 10 is a schematic diagram of a computer system.

### DETAILED DESCRIPTION

It is to be understood that the present disclosure provides many different embodiments, or examples, for implementing different features of various embodiments. Specific examples of components and arrangements are described below to simplify the present disclosure. These are, of course, merely examples and are not intended to be limiting.

The present disclosure provides a workflow and systems that perform sonic measurements in a high-angle wellbore or horizontal wellbore or vertical wellbore penetrating highly dipped formation layers where the formation layers can have a high degree of dip relative to the wellbore. Sonic data can be generated from the sonic measurements and processed using dual/multiple arrival event processing to determine formation porosity as well as elastic rock properties and geometric information for a tool layer and shoulder bed. The tool layer is disposed in a near-wellbore region that surrounds (or at least partially surrounds) the wellbore. The shoulder bed can include one or more formation layers disposed above or below the tool layer in a high-angle wellbore or horizontal wellbore, or the shoulder bed can include one or more formation layers disposed on opposite sides of the tool layer in a vertical wellbore penetrating dipped formation layers. Such information can be integrated into a 2D or 3D layered model of the formation constructed from wellbore image data and electromagnetic measurements of the formation. Moreover, the elastic rock properties of the tool layer and shoulder bed derived from the dual/multiple arrival event processing can provide more representative elastic property values, which can account for heterogeneity along the wellbore.

Furthermore, the workflow can use at least part of the formation porosity, the elastic rock properties and geometric information for the tool layer and shoulder bed as derived from the sonic measurements for well placement (geosteering) and well completion optimization.

In embodiments, the present disclosure describes a workflow for drilling and placing a wellbore that traverses a formation which generally includes a tool layer (reservoir layer) that is disposed in a near-wellbore region that surrounds (or at least partially surrounds) the wellbore and a nearby shoulder bed. The shoulder bed can include one or more formation layers disposed above or below the tool layer. In embodiments, the wellbore can be a high-angle wellbore or horizontal wellbore or vertical wellbore penetrating highly dipped formation layers where the formation layers can have a high degree of dip relative to the wellbore. The workflow involves performing sonic measurements in the wellbore to obtain sonic data that can be interpreted to characterize properties of the formation layers adjacent to the wellbore. The sonic data is processed to determine distance to and dip/azimuth of the shoulder bed boundary and determine formation properties (such as porosity) and other properties (such as elastic rock properties and stress profile) of the tool layer and shoulder bed. The workflow can be performed while drilling and the resulting information or parts thereof can be used to control geosteering of the drilling operation. Additionally or alternatively, the resulting information or parts thereof can also be used in completing the wellbore (for example, in the design and implementation of a completion for the wellbore). The properties of the tool layer and the shoulder bed (such as elastic rock properties and stress profile) can be integrated into a one-dimensional (1D) layered model of the formation or a three-dimensional (3D) geomechanical model of the formation, which can be used for simulating stimulation of the formation and/or determining parameters associated with stimulation of the formation.

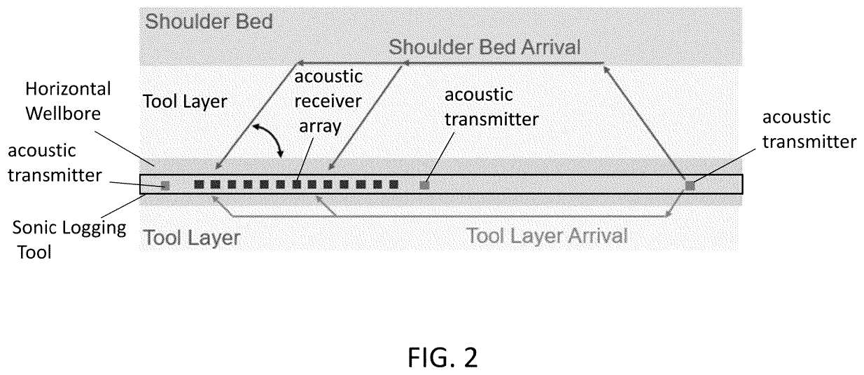

FIG. 2 shows a sonic logging tool that includes a number of acoustic transmitters (e.g., monopole, dipole, or quadrupole acoustic sources) spaced from an array of acoustic receivers (which can include acoustic receivers disposed at different axial and azimuthal positions about the tool body). The sonic logging tool can be deployed in a wellbore as shown and configured to perform sonic measurements in the wellbore whereby acoustic energy emitted from an acoustic transmitter of the tool interacts with the surrounding formation layers and is then received by the array of acoustic receivers of the tool. The tool can be further configured to generate and store sonic data that results from such sonic measurements. The sonic data includes components that represent both tool layer arrivals and shoulder bed arrivals. The tool layer arrivals include compressional (P) arrivals and shear (S) arrivals arising from propagation in the tool layer. The shoulder bed arrivals include compressional (P) arrivals and shear (S) arrivals arising from refraction and reflection along the nearby shoulder bed. The propagation paths for the compressional and shear wavefronts through the tool layer and nearby shoulder bed are illustrated schematically in FIG. 2.

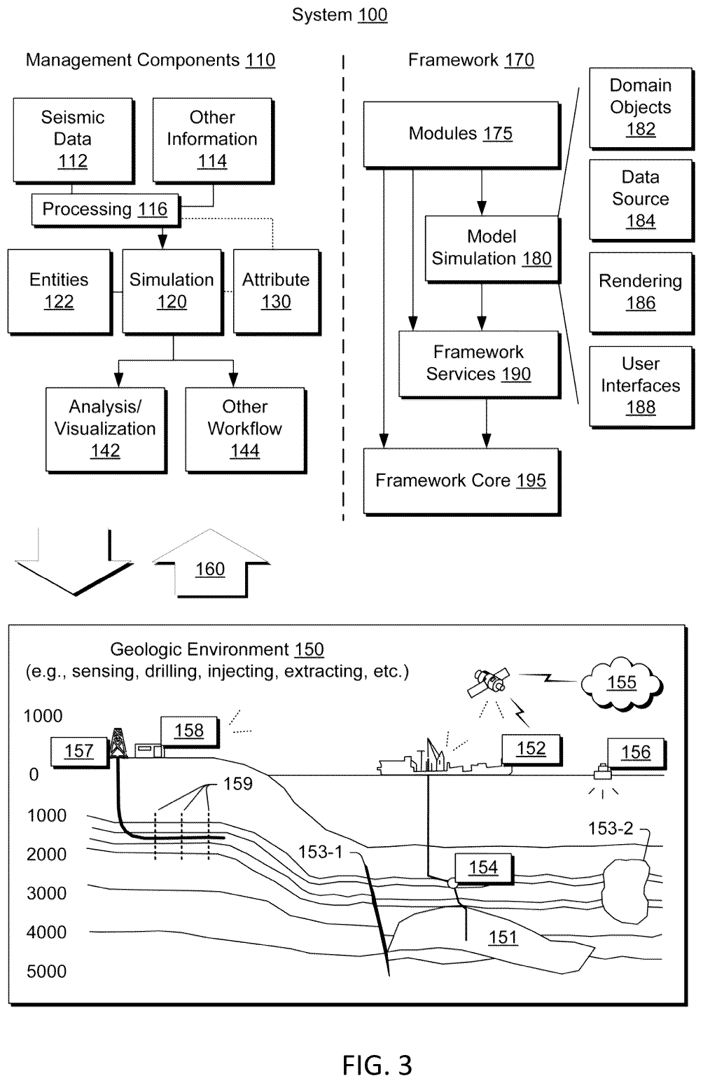

FIG. 3 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 3, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond. Washington), which provides a set of extensible object classes. In the .NET™ framework, an object class encapsulates a module of reusable code and associated data structures. Object classes can be used to instantiate object instances for use in by a program, script, etc. For example, borehole classes may define objects for representing wellbores based on well data.

In the example of FIG. 3, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 3, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited. Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited. Houston. Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited. Houston, Texas) allows for integration of add-ons (or plug-ins) into a PETREL® framework workflow. The OCEAN® framework environment leverages .NET® tools (Microsoft Corporation, Redmond. Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 3 also shows an example of a framework 170 that includes a model simulation layer 180 along with a framework services layer 190, a framework core layer 195, and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 3, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 3, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results, and cases. Thus, upon completion of a modeling session, a user may store a project. At a later time, the project can be accessed and restored using the model simulation layer 180, which can recreate instances of the relevant domain objects.

In the example of FIG. 3, the geologic environment 150 may include layers (e.g., stratification) that include a reservoir 151 and one or more other features such as a fault 153-1, a geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 3 shows a satellite in communication with the network 155 that may be configured for communications, noting that the satellite may additionally or alternatively include circuitry for imagery (e.g., spatial, spectral, temporal, radiometric, etc.).

FIG. 3 also shows the geologic environment 150 as including equipment 157 and 158 associated with a well that includes a substantially horizontal portion that may intersect with a reservoir with one or more fractures 159 extending therefrom. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via drilling and completing a well, fracturing, injecting, extracting, monitoring, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workflow may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on sonic data as well as other log data as described herein. As an example, a workflow may be a process implementable in the OCEAN® framework. As an example, a workflow may include one or more worksteps that access a module such as a plug-in (e.g., external executable code, etc.).

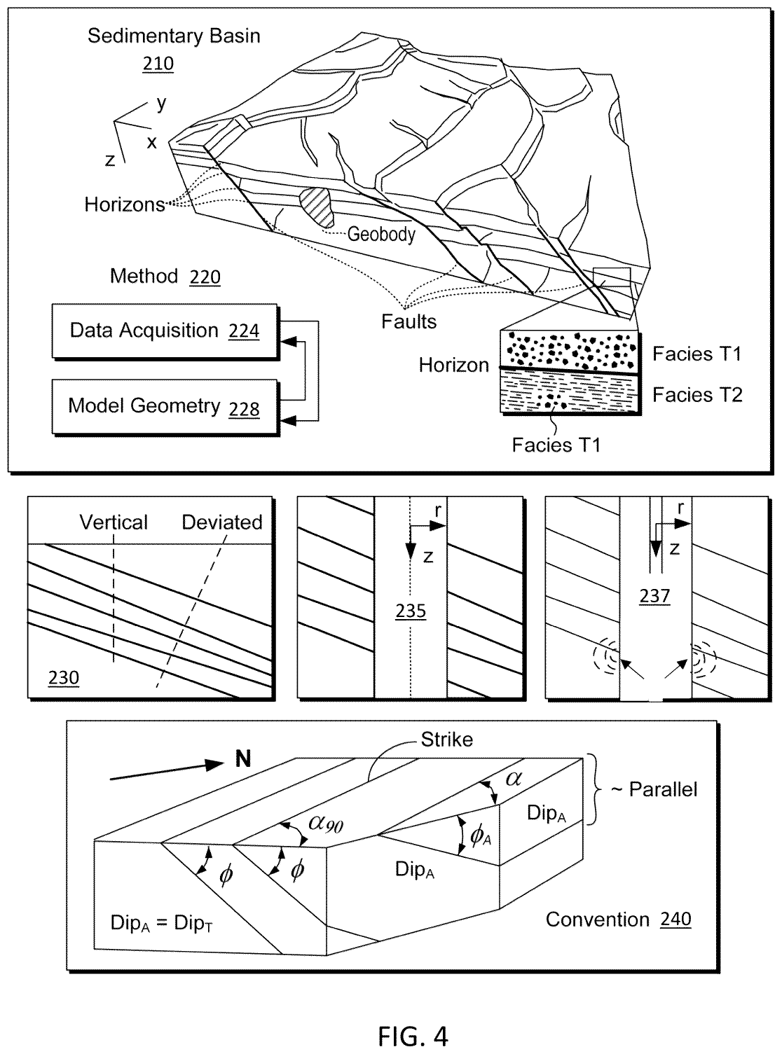

FIG. 4 shows an example of a sedimentary basin 210 (e.g., a geologic environment), an example of a method 220 for model building (e.g., for a simulator, etc.), an example of a formation 230, an example of a wellbore 235 in the formation, and an example of a convention 240. As an example, reservoir simulation, petroleum systems modeling, etc. may be applied to characterize various types of subsurface environments, including environments such as those of FIGS. 3 and 4.

In FIG. 4, the sedimentary basin 210, which is a geologic environment, includes horizons, faults, one or more geobodies and geological facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Texas) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 4, the formation 230 includes a generally horizontal surface and various subsurface layers. As an example, a wellbore may be vertical. As another example, a wellbore may be deviated. In the example of FIG. 4, the wellbore 235 may be considered a vertical wellbore, for example, where the z-axis extends downwardly normal to the horizontal surface of the formation 230. As an example, a tool 237 may be positioned in a wellbore, for example, to acquire information. As mentioned, a downhole tool may be configured to acquire sonic data. As an example, the SonicScope tool (Schlumberger Limited, Houston, Texas) can acquire sonic data while drilling. The tool may be integrated into the drill collar that supports a drill bit and run in a wellbore as the drill bit drills the wellbore. As an example, the wellbore may be vertical, deviated and/or horizontal. As an example, the tool 237 may be positioned to acquire information in a horizontal portion of a wellbore. Analysis of such information may reveal vugs, dissolution planes (e.g., dissolution along bedding planes), stress-related features, dip events, etc. As an example, the tool 237 may acquire information that may help to characterize a reservoir. Such information may assist with geosteering, stimulation treatment, completions, etc. As an example, information acquired by a tool may be analyzed using a framework such as the TECHLOG® framework.

As to the convention 240 for dip shown in FIG. 4, the three-dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 4, various angles ϕ indicate angle of slope downwards, for example, from an imaginary horizontal plane (e.g., flat upper surface); whereas dip refers to the direction towards which a dipping plane slopes (e.g., which may be given with respect to degrees, compass directions, etc.). Another feature shown in the convention of FIG. 4 is strike, which is the orientation with respect to North (N) of the line created by the intersection of a dipping plane and a horizontal plane (e.g., consider the flat upper surface as being an imaginary horizontal plane).

Some additional terms related to dip and strike may apply to characterization and analysis of dip in subsurface formation layers. One term is “true dip” (see, e.g., Dip_{T} in the convention 240 of FIG. 4). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 4). Apparent dip may be the dip of a plane as measured in any other direction except in the direction of true dip (see, e.g., ϕ_{A} as Dip_{A} for angle α); however, it is possible that the apparent dip is equal to the true dip (see. e.g., ϕ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 4, the dip of a plane as seen in a cross-section perpendicular to the strike is true dip (see, e.g., the surface with ϕ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 4, the apparent dip may be approximately 0 degrees (e.g., parallel to a horizontal surface where an edge of a cutting plane runs along a strike direction).

In terms of observing dip in wellbores, true dip is observed in wells drilled vertically. In wellbores drilled in any other orientation (or deviation), the dips observed are apparent dips (e.g., which are referred to by some as relative dips). In order to determine true dip values for planes observed in such wellbores, as an example, a vector computation (e.g., based on the wellbore deviation) may be applied to one or more apparent dip values.

A convention such as the convention 240 may be used with respect to analysis, interpretation, and characterization of subsurface formation features (see. e.g., various blocks of the system 100 of FIG. 3). As an example, various types of features may be described, in part, by dip (e.g., sedimentary bedding or layers, faults and fractures, cuestas, igneous dikes and sills, metamorphic foliation, etc.).

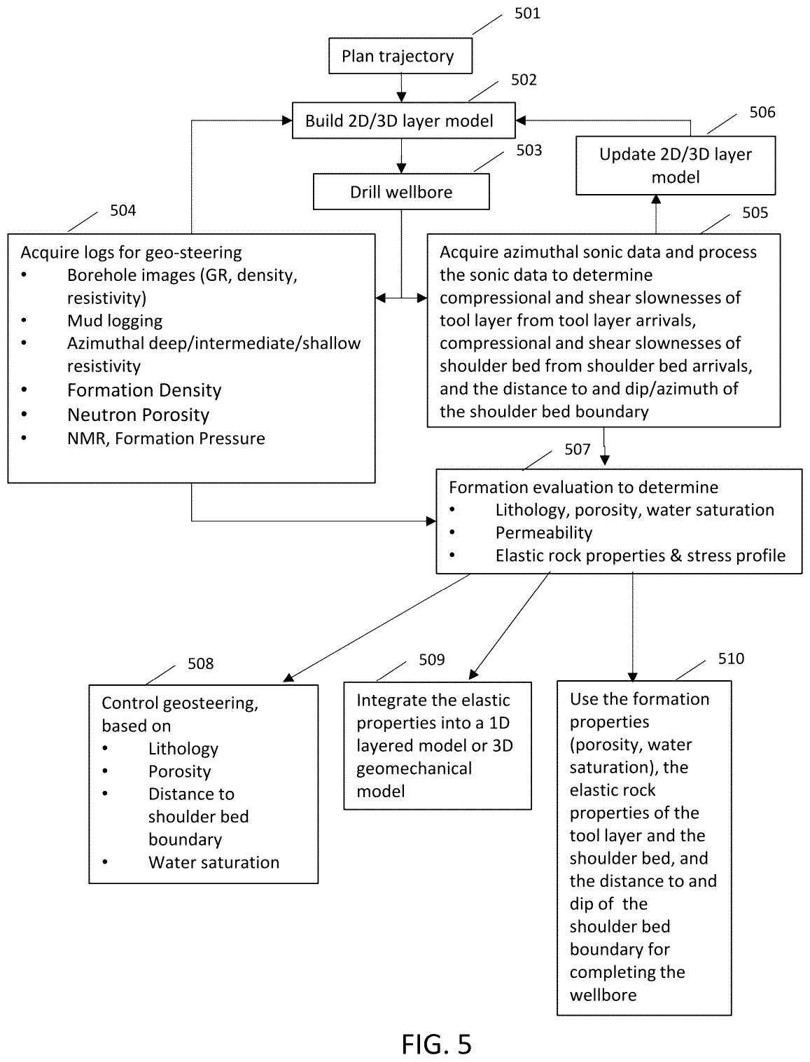

An example embodiment of a workflow for drilling and placing a wellbore that intersects and traverses a reservoir formation is shown in FIG. 5 and described below. In embodiments, the formation has layers that have a high degree of dip relative to the wellbore or portion thereof.

The workflow begins in block 501, which involves planning a trajectory for a wellbore that is expected to intersect and traverse a reservoir formation. In embodiments, the formation has layers that have a high degree of dip relative to the wellbore or portion thereof. For example, the wellbore can be a high-angle wellbore or horizontal wellbore or vertical wellbore penetrating highly dipped formation layers where the formation layers can have a high degree of dip relative to the wellbore.

In block 502, the workflow builds or constructs a two-dimensional (2D) or three-dimensional (3D) geological model of the formation along the planned trajectory of 501. The 2D or 3D geological model can include information representing spatial positions of major formation boundaries (e.g. faults) and information representing spatial positions of major stratigraphic layers of the formation. In the event that the formation layers have a high degree of dip relative to the wellbore, the formation layers will generally include a tool layer (reservoir layer) and a nearby shoulder bed as shown in FIG. 2. In embodiments, the tool layer can be disposed in a near-wellbore region that surrounds (or at least partially surrounds) the wellbore or interval thereof. Formation properties, such as resistivity, porosity, permeability, oil saturation, gas saturation, water saturation, elastic rock properties (e.g. rock stiffness), etc. can be associated with the layers (or cells within the layers) of the geological model as determined by the workflow.

In block 503, drilling operations begin to start drilling a wellbore according to the planned well trajectory of 501.

In block 504, measurements of measurement-while-drilling (MWD), including inclination and azimuth, and logging while drilling (LWD) such as density, neutron porosity, gamma ray and resistivity logs are acquired or obtained from one or more downhole tools located within the wellbore while drilling to confirm and update the geological model (including spatial position of one or more formation layers) while drilling for control of geosteering of the drilling operation for evaluation of formation lithology, porosity, and water saturation. The geosteering control can involve intentional directional control of the wellbore based on the results of downhole geological logging measurements rather than drilling according to a pre-planned well trajectory to a three-dimensional target in space. The goal of the geosteering is usually to keep a directional wellbore within a pay zone, where reservoir water saturation is low and hydrocarbon saturation is high. Often geosteering may be used to keep a wellbore in a particular section of a reservoir to delay and minimize gas or water breakthrough and maximize economic production from the well.

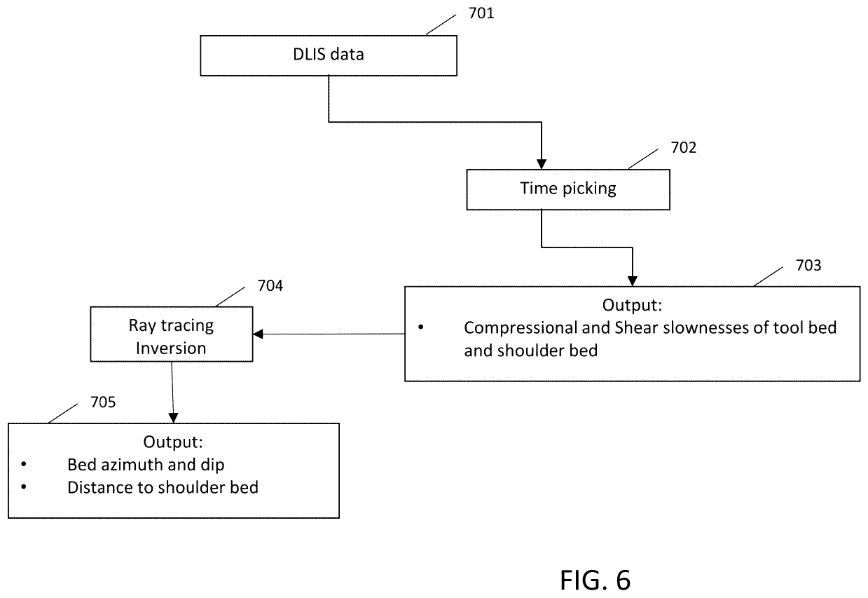

In block 505, azimuthal sonic data is acquired or obtained from a downhole tool located within the wellbore while drilling (or by a downhole tool located in the wellbore and conveyed on drill pipe, coil tubing, through-the-bit, or wireline). The sonic data is processed to determine compressional and shear slownesses of the tool layer from tool layer arrivals, compressional and shear slownesses of the shoulder bed from shoulder bed arrivals, and distance to and the dip/azimuth of the shoulder bed boundary. An example of operations that process azimuthal sonic data to determine compressional and shear slownesses of the tool layer from tool layer arrivals, compressional and shear slownesses of the shoulder bed from shoulder bed arrivals, and distance to shoulder bed boundary and the dip/azimuth of the shoulder bed is summarized in FIG. 6.

In block 506, the dip and azimuth of the shoulder bed and the distance to the shoulder bed boundary of block 505 can be used to update the geological model, such as updating the spatial position of the shoulder bed in the geological model.

In block 507, the compressional and shear slownesses of block 505 and the log data of block 504 can be used in formation evaluation to derive porosity, permeability, water saturation, and elastic properties of the reservoir rock.

In embodiments, the compressional and shear slowness estimates for the tool layer and the shoulder bed of block 505 can be related to the formation layer porosity, permeability, saturation, and elastic properties through various observed empirical relations and rock physics models.

For example, Brie, F. Pampuri, A. Marsala, O. Meazza, “Shear Sonic Interpretation in Gas-Bearing Sands,” SPE 30595, SPE Annual Technical Conference and Exhibition, Dallas, October 1995, describes using a ratio of compressional velocity (Vp) to shear velocity (Vs) versus compressional slowness (1/Vp) to empirically discriminate formation rocks according to their lithology (i.e., shale, shaly sands, limestone, dolomite, salt), saturation (i.e., dry versus wet pore spaces), and fluid content (i.e., water versus gas). These empirical relations can be used to relate the ratio of compressional velocity (Vp) to shear velocity (Vs) versus compressional slowness (1/Vp) of the tool layer of block 505 to characterize the lithology, saturation, and the fluid content of the tool layer. Furthermore, such empirical relations can be used to relate the ratio of compressional velocity (Vp) to shear velocity (Vs) versus compressional slowness (1/Vp) of the shoulder bed of block 505 to characterize the lithology, saturation, and fluid content of the shoulder bed.

Furthermore, the porosity of the reservoir rock relates to the velocity of the compressional wave propagating through a porous rock whereby the travel time is proportional to the individual components of the rock matrix and the fluids in the pore space. Early studies in the laboratory examined the compressional velocity of various minerals, fluids and their size and distribution with the matrix. The equation for the time average sonic porosity is as follows:

$$\frac{1}{v} = \frac{ϕ}{{v}_{f}} + \frac{( 1 - ϕ )}{{v}_{ma}} , \qquad Eqn . ( 1 )$$

where ϕ is the sonic porosity of the formation, ν is the compressional velocity of the formation (ft/sec). ν_{f} is the compressional velocity of pore fluids (ft/scc), and νₘₐ is the compressional velocity of the rock matrix (ft/sec).

The sonic porosity of the formation can also be related to compressional slownesses of the pore fluids and the rock matrix as follows:

Δt=ØΔt_{f}+(1−Ø)Δtₘₐ, Eqn. (2)

where Δt is the compressional slowness (psec/ft), Δt_{f} is the compressional slowness of pore fluids (μsec/ft), and Δtₘₐ is the compressional slowness of the rock matrix (μsec/ft).

Eqn. (2) can be rewritten to solve for ϕ as follows:

$$ϕ = \frac{Δ t - Δ {t}_{ma}}{Δ {t}_{f} - Δ {t}_{ma}} . \qquad Eqn . ( 3 )$$

Table A below lists the bulk density, sonic slowness, and ratio of compressional to shear slowness of common rock types.

TABLE A

| Material | ρma (g/cc) | Δtc(μsec/ft) | Δts(μsec/ft) | Vp/Vs |
|---|---|---|---|---|
| Sandstone | 2.65 | 55.5 | 88.0 | 1.59 |
| Limestone | 2.71 | 47.5 | 88.5 | 1.86 |
| Dolomite | 2.85 | 43.5 | 78.5 | 1.80 |
| Anhydrite | 2.98 | 50 | 92.0 | 1.84 |
| Halite | 2.16 | 67 | 116.5 | 1.73 |

Table B below lists typical compressional slowness of common formation fluids.

TABLE B

| Fluid | Δtc (μsec/ft) |
|---|---|
| Brine | 180 |
| Water based mud | 190 |
| Oil based mud | 255 |

Eqns. (1) to (3) above can thus be used to relate compressional slowness of the tool layer of block 505 to characterize the porosity of the tool layer. Similarly, eqns. (1) to (3) can be used to relate compressional slowness of the shoulder bed of block 505 to characterize the porosity of the shoulder bed.

Moreover, estimates of compressional velocity (Vp) and shear velocity (Vs) permits one to form their ratio (Vp/Vs) which is related to Poisson's ratio ν, for isotropic rocks is given by:

$$v = \frac{{( \frac{{V}_{p}}{{V}_{s}} )}^{2} - 2}{2 {( \frac{{V}_{p}}{{V}_{s}} )}^{2} - 2} . \qquad Eqn . ( 4 )$$

Poisson's ratio is a key elastic property of reservoir rocks as it expresses the ratio of transverse contraction strain to longitudinal extension strain in the direction of stretching force. Poisson's ratio depends on lithology, confining stress, pore pressure, and porosity of the rock. For example, laboratory test results show that static Poisson's ratio increases as porosity increases. Eqn. (4) can thus be used to relate the ratio of compressional velocity to shear velocity of the tool layer of block 505 to characterize Poisson's ratio of the tool layer. Similarly, Eqn. (4) can be used to relate the ratio of compressional velocity to shear velocity of the shoulder bed of block 505 to characterize Poisson's ratio of the shoulder bed.

Poisson's ratio can also be helpful for discriminating permeability of the reservoir rock as described in Diaz. Elizabeth & Prasad. Manika & Mavko. Gary & Dvorkin, Jack, “Effect of glauconite on the elastic properties, porosity, and permeability of reservoir rocks,” The Leading Edge, 22, 2003, pgs. 42-45. 10.1190/1.1542755. Thus, Poisson's ratio of the tool layer can be used to estimate permeability of the tool layer, and Poisson's ratio of the shoulder bed can be used to estimate permeability of the shoulder bed.

In block 508, geosteering of the drilling operation can be controlled based on the formation lithology, porosity, and water saturation of block 507 and the distance to the shoulder bed boundary of 505. The geosteering control can be part of block 504 or performed as an update to such geosteering control. The geosteering control can involve intentional directional control of the wellbore based on the results of downhole geological logging measurements rather than drilling according to a pre-planned well trajectory to a three-dimensional target in space. The goal of the geosteering is usually to keep a directional wellbore within a pay zone, part of the reservoir where water saturation is low and hydrocarbon saturation is high. Often geosteering may be used to keep a wellbore in a particular section of a reservoir to delay and minimize gas or water breakthrough and maximize economic production from the well. An example of geosteering is described in detail in Beer et al., “Geosteering And/Or Reservoir Characterization The Prowess Of New-Generation LWD Tools.” SPWLA 51st Annual Logging Symposium. Paper No. 93320, 2010.

Locating and characterizing the tool layer (reservoir pay zone) as well as nearby formation layers (shoulder bed) in terms of their lithology, porosity, and fluid saturation (gas, oil or water) is critical for a successful geosteering operation. In the workflow, dual arrival events processing of the sonic data can be used to characterize the lithology, porosity, and fluid contents for the tool layer and for nearby shoulder bed, as well as determine the distance to and azimuth direction to the nearby shoulder bed (i.e., the tool sonde is currently located in a high porosity oil-filled sand and is 4 feet below a low porosity shale layer). This information can be used to intentionally control the direction of the drilling of the wellbore towards a successful well placement operation while drilling.

In block 509, the elastic properties of the tool layer and shoulder bed layer of 507 can be integrated into a one-dimensional (1D) layered model or a three-dimensional (3D) geomechanical model. The resulting 1D layered model or 3D geomechanical model can be used for simulating stimulation of the formation and/or determining parameters associated with stimulation of the formation. Stimulation is a treatment performed to restore or enhance the productivity of a well. Stimulation treatments fall into two main groups; hydraulic fracturing treatments and matrix treatments such as acidizing. Fracturing treatments are performed above the fracture pressure of the reservoir formation and create a highly conductive flow path between the reservoir and the wellbore. Matrix treatments are performed below the reservoir fracture pressure and generally are designed to restore the natural permeability of the reservoir formation following damage to the near-wellbore area. Stimulation in shale gas reservoirs typically takes the form of hydraulic fracturing treatments.

For an isotropic medium there are two independent parameters, shear modulus G and Poisson's ratio ν, which can be computed from the sonic velocities and bulk density ρ_{b} as follows:

$$G = {ρ}_{b} {V}_{s}^{2} , and \qquad Eqn . ( 5 a )$$

$$v = \frac{2 {V}_{s}^{2} - {V}_{p}^{2}}{2 ( {V}_{s}^{2} - {V}_{p}^{2} )} . \qquad Eqn . ( 5 b )$$

The Young's modulus E is expressed in this relationship as:

E=2G(1+ν). Eqn. (6)

These moduli can be calculated directly from the compressional and shear sonic measurements data and are described as “dynamic” moduli. The dynamic moduli can then be converted to ‘static’ moduli using core measurements made in the laboratory. Since the dynamic moduli are determined from higher frequency sonic measurements, they are almost always higher than the lower frequency static values which represent in-situ downhole conditions. The static elastic moduli are used to model formation stresses when combining with a constitutive model which includes pore pressure and overburden loading, though some applications may be frequency dependent.

Geomechanical modeling can use the dynamic measurements from sonic data to determine elastic properties, rock strength and pore pressure of the reservoir rock. Rock strength is often stated in terms of unconfined compressive strength or UCS. The UCS of the rock is measured in the laboratory using core samples which are subjected to mechanical destructive testing. There is no direct measurement of UCS using well logs, however the strength of the rock is routinely correlated to the Young's modulus, or directly from the sonic compressional velocity.

For a 1-dimensional (1D) model of the in-situ stress along a lateral wellbore, the traditional equations used to estimate stress magnitude assume an isotropic poro-elastic medium, and are shown in the equations (7a) and (7b) below, where E is Young's Modulus, v is Poisson's Ratio, σₕ is minimum horizontal stress, σ_{H} is maximum horizontal stress, σ_{ν} is overburden stress. \acute{α} is Biot's constant, εₕ is the minimum principal horizontal strain and ε_{H} is the maximum principal horizontal strain.

$${σ}_{h} - {ασ}_{pp} = \frac{v}{1 - v} ( {σ}_{v} - α {σ}_{pp} ) + \frac{E}{1 - {v}^{2}} {ε}_{h} + \frac{Ev}{1 - {v}^{2}} {ε}_{H} , \qquad Eqn . ( 7 a )$$

$${σ}_{H} - α {σ}_{pp} = \frac{v}{1 - v} ( {σ}_{v} - α {σ}_{pp} ) + \frac{E}{1 - {v}^{2}} {ε}_{H} + \frac{Ev}{1 - {v}^{2}} {ε}_{h} . \qquad Eqn . ( 7 b )$$

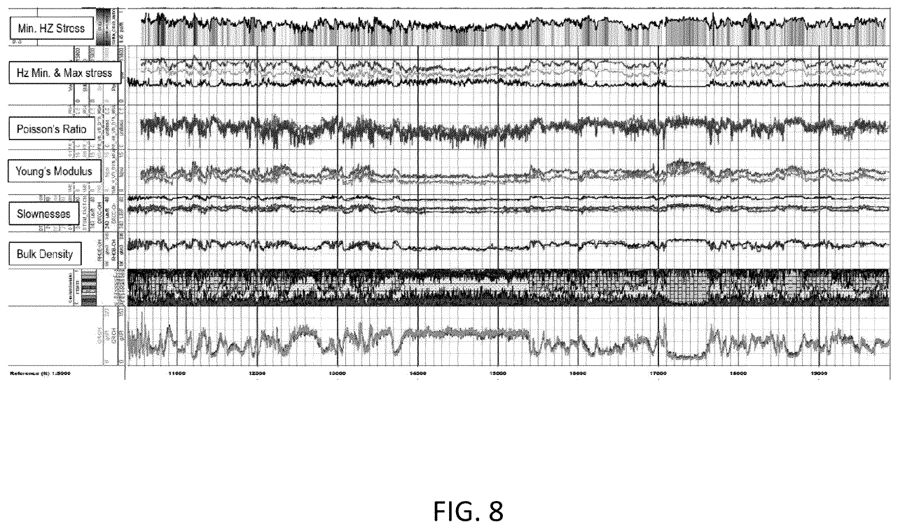

FIG. 8 illustrates an example 1D model of elastic properties (Poisson's ratio) and stress properties distributed along a lateral wellbore.

For a three-dimensional (3D) structured geomechanical model, the elastic properties (Young's modulus and Poisson's Ratio) are distributed by one or more layers within the 3D model. The stress state is determined using these elastic properties and a 3D poro-elastic equation considering boundary stress conditions which are like the tectonic strain parameters in the 1D model.

The resulting 1D layered model or 3D geomechanical model can be used for simulating stimulation of the formation and/or determining parameters associated with stimulation of the formation.

For example, perforations and hydraulic frac stage placement can be determined from the stress and mechanical property profile of the resulting model. Specifically, the hydraulic frac stage can be placed in the lowest stressed zones with the highest porosity and hydrocarbon saturation. The sonic porosity is used for the porosity, and the dynamic elastic moduli are directly used in the stress profile. After the optimum zones for stimulation are identified, then the stimulation parameters are determined. These parameters include the following non-exhaustive list: fluid type, proppant concentration, pump rate, number and phasing of perforations, perforation entry hole width and total volume of desired proppant to be placed. The parameters derived from the sonic measurements through the model that impact the stimulation parameters are the fracture width, rock strength and the net pressure, or stress differential between the stimulated layer and boundary layers. In embodiments, the fluid type, proppant concentration and proppant size can be determined using the hydraulic fracture width, which can be directly determined by the Young's modulus; the perforation entry hole can be determined by the perforation charge size, which is a function of rock strength; and the net pressure can be derived from the stress profile along the well.

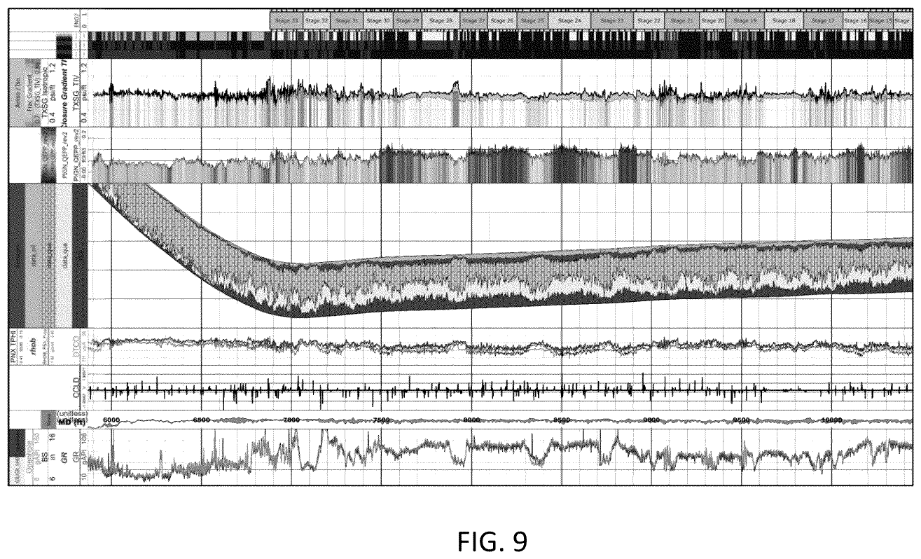

FIG. 9 illustrates examples of rock and fluid properties together with perforations and fracture stages distributed along lateral perforations and hydraulic frac stage placement along a lateral wellbore that can be optimized as part of the workflow of the present disclosure.

In block 510, the formation properties (porosity, water saturation, and elastic rock properties) of 507 and the dip and distance to the shoulder bed boundary of 505 can be used in completing the wellbore, for example, in the design and implementation of a completion for the wellbore.

For horizontal wells, there are various types of completion designs, which include 1) openhole completion, 2) slotted liner in open hole, 3) slotted linear in open hole with blank sections and use of inflow control devices (ICD's), and 4) cased cemented and perforated completion. The options have benefits and drawbacks when it comes to the length of the reservoir interval, type of hydrocarbon (gas or oil), lithology (carbonate or elastic) and rock properties (permeability, porosity, fractures). When drilling the lateral wellbore, the goal is to have as much reservoir contact within the reservoir layer as possible. Some, if not most reservoirs have lateral heterogeneity. Thus, it is anticipated that the entire length of the lateral will not 100% contain optimal reservoir rock which is saturated with hydrocarbon. So, there are often decisions made on the specific zones to complete. If the porosity is inaccurate, then the length of the interval to complete could be over or underestimated. Similarly, if the shoulder bed is closer than originally thought, then the flow unit may have less effective production than originally thought. Given uncertainties in these rock properties, the completion type may change depending on these parameters.

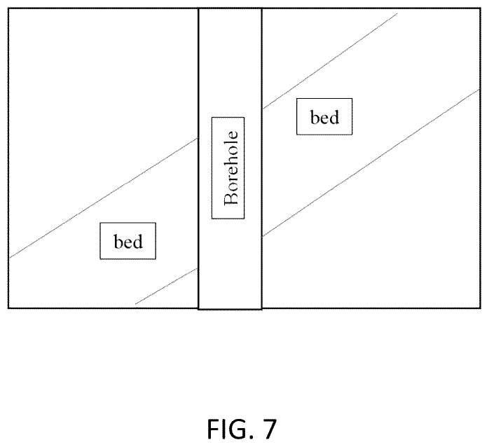

In embodiments, the sonic data processing of block 505 can employ a dual arrival events workflow as shown in FIG. 6. The dual arrival events workflow provides logs of tool layer and shoulder bed compressional and shear slowness which are necessary for making estimates of elastic rock properties and petrophysics properties, including formation porosity. In addition, the dual arrivals workflow can provide geometric information of the formation layers, including estimates of relative dip of and distance to the shoulder bed boundary. The dual arrivals workflow begins in block 701 by obtaining sonic data (labeled “DLIS sonic data”) that contains the sonic waveforms and preliminary estimates of formation compressional (P) and shear (S) slowness. The dual arrival events time picking of block 702 generates logs of compressional (P) and shear (S) slowness values for the tool layer and for the shoulder bed (block 703). The dual arrivals ray tracing inversion of block 704 uses the estimates of compressional (P) and shear (S) slowness of the tool layer from the log of 703 to invert the time picks to output geometric information of the formation, such as the relative dip and azimuth of the shoulder bed boundary and estimates of the distance to the shoulder bed in block 705. Details of the dual arrival events workflow of FIG. 7 is described in PCT Publication No. WO2015168417A1, entitled “Geological modeling workflow”, commonly assigned to the assignee of the present application.

While the disclosed workflow is envisioned to be most helpful in horizontal and high-angle wells, the workflow can also be applied in vertical wells that intersect high-angle beds where the relative angle between the well path and the bed dip will be small as shown in FIG. 7. In such a situation, dual arrival events are also expected to be observed which will introduce the same challenges as horizontal wells.

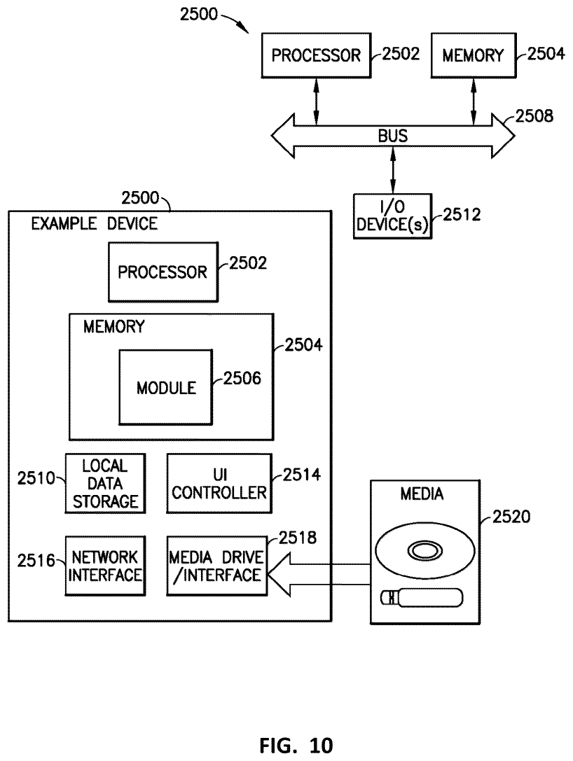

In some embodiments, the methods and systems of the present disclosure may involve a computing system. FIG. 10 illustrates an example computing system 2500, with a processor 2502 and memory 2504 that can be configured to implement various embodiments of the subject disclosure. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various systems and processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable, and non-removable tangible media implemented for storage of information such as computer readable instructions, data structures, program modules, or other data. Computer storage media include, but are not limited to, RAM, ROM. EEPROM, flash memory or other memory technology. CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Some of the methods and processes described herein can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Some of the methods and processes described herein can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer-readable medium (e.g., memory) and executed by the computer processor. The computer instructions may be distributed in any form as a removable storage medium with accompanying printed or electronic documentation (e.g., shrink-wrapped software), preloaded with a computer system (e.g., on system ROM or fixed disk), or distributed from a server or electronic bulletin board over a communication system (e.g., the Internet or World Wide Web).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claims expressly uses the words ‘means for’ together with an associated function.

What is claimed is:

1. A method comprising:
acquiring or obtaining sonic data from sonic measurements in a wellbore that traverses a formation having layers that have a high degree of dip relative to the wellbore; and
processing the sonic data using multiple arrival event processing to determine properties characterizing a tool layer and shoulder bed of the formation, the properties including porosity, elastic rock properties and geometric information for the tool layer and shoulder bed, respectively;
wherein the tool layer is disposed in a near-wellbore region that surrounds or at least partially surrounds the wellbore, and the shoulder bed is disposed adjacent the tool layer.

2. A method according to claim 1, wherein:
the wellbore comprises a horizontal wellbore or high angle wellbore.

3. A method according to claim 1, wherein:
the wellbore comprises a vertical wellbore that traverses highly dipped formation layers.

4. The method according to claim 1, wherein:
the processing of the sonic data determines i) compressional and shear slownesses of the tool layer from tool layer arrivals, ii) compressional and shear slownesses of the shoulder bed from shoulder bed arrivals.

5. The method according to claim 4, wherein:
the processing of the sonic data further determines iii) distance to the shoulder bed as well as dip and azimuth of the shoulder bed using ray tracing inversion.

6. The method according to claim 4, wherein:
the processing of the sonic data determines iv) porosity and elastic properties of the tool layer using the compressional and shear slownesses of the tool layer in conjunction with empirical relations and rock physics models and v) porosity and elastic properties of the shoulder bed using the compressional and shear slownesses of the shoulder bed in conjunction with the empirical relations and rock physics models.

7. The method according to claim 4, wherein:
the processing of the sonic data further determines vi) permeability of the tool layer using the compressional and shear slownesses of the tool layer and vii) permeability of the shoulder bed using the compressional and shear slownesses of the shoulder bed.

8. A method according to claim 1, further comprising:
integrating the properties including porosity, water saturation, elastic rock properties and geometric information for the tool layer and shoulder bed into a two-dimensional layered model of the formation or a three-dimensional layered model of the formation.

9. A method according to claim 8, wherein:
the two-dimensional layered model of the formation or three-dimensional layered model of the formation is constructed from at least one of wellbore image data and electromagnetic measurements of the formation.

10. A method according to claim 8, further comprising:
using the two-dimensional layered model of the formation or the three-dimensional layered model of the formation for control of geosteering or directional drilling while drilling the wellbore.

11. A method according to claim 1, wherein:
using at least part of the properties including porosity, elastic rock properties and geometric information for the tool layer and shoulder bed for control of geosteering or directional drilling while drilling the wellbore.

12. A method according to claim 1, further comprising:
using at least part of the properties including porosity, elastic rock properties and geometric information for the tool layer and shoulder bed for completing the wellbore.

13. A method according to claim 1, further comprising:
integrating at least part of the properties including porosity, elastic rock properties and geometric information for the tool layer and shoulder bed into a one-dimensional layered model of the formation or a three-dimensional geomechanical model of the formation.

14. A method according to claim 13, further comprising:
using the one-dimensional layered model of the formation or the three-dimensional geomechanical model of the formation for simulating stimulation of the formation and/or determining parameters associated with stimulation of the formation.

15. A method according to claim 1, further comprising:
operating a sonic logging tool in the wellbore to perform sonic measurements that generate the sonic data.

16. A method according to claim 15, wherein:
the sonic logging tool is operated while drilling the wellbore to perform the sonic measurements that generate the sonic data while drilling the wellbore; and
at least part of the properties including porosity, elastic rock properties and geometric information for the tool layer and shoulder bed are used to control geosteering or directional drilling while drilling the wellbore.

17. A processor executing instructions configured to:
acquire or obtain sonic data from sonic measurements in a wellbore that traverses a formation having layers that have a high degree of dip relative to the wellbore; and
process the sonic data using multiple arrival event processing to determine properties characterizing a tool layer and shoulder bed of the formation, the properties including porosity, elastic rock properties and geometric information for the tool layer and shoulder bed, respectively;
wherein the tool layer is disposed in a near-wellbore region that surrounds or at least partially surrounds the wellbore, and the shoulder bed is disposed adjacent the tool layer.
